(19) United States
(12) Patent Application Publication
(10) Pub. No.: US 2004/0204138 A1
(43) Pub. Date: Oct. 14, 2004

(54) System and method for downloading data

(76) Inventors: Wing Nam Tse, Hong Kong (HK); Chi Fai Chan, Laguna City (HK)

Correspondence Address: SHAW PITTMAN LLP, 1650 TYSONS BOULEVARD, MCLEAN, VA, 22102, US

(21) Appl. No.: 10/338,014

(22) Filed: Jan. 8, 2003

(51) Int. Cl. H04B 1/38

(52) U.S. Cl. 455/566; 455/550.1

(57) ABSTRACT

A system and method transferring a data file is disclosed. One embodiment of the invention is a cable that is configured to transfer a data file from a data source to a handset of a cordless telephone. Another embodiment of the invention is a handset of a cordless telephone that is configured to receive a data file and to play the data file during an operation mode associated with the data file. The preferred data file is an animation file.

### BACKGROUND

1. Field of the Invention

The present invention relates generally to a cordless telephone and, more particularly, to a method and system for downloading data to a handset of a cordless telephone.

2. Background of the Invention

A conventional handset of a cordless telephone does not have animation capabilities. Since many users desire to have a unique feature on their cordless telephone that identifies them, there is a need for a handset that allows its users to download and play animation. Currently, there is no known cordless telephone that can download or play animation on its handset.

### SUMMARY OF THE INVENTION

The invention provides a system and method for transferring data from a data source to a handset of a cordless telephone.

In one aspect, the invention provides a cable including a first end configured to mate with a data source, a second end configured to mate with a handset, and a data converter for converting a first format of data received via the first end into a second format for delivery via the second end. Preferably, the first end is a USB plug. Preferably, the second end is a headphone jack. Preferably, the first format uses USB v1.1 communications protocol. Preferably, the second format uses EIA-232 communications protocol.

In another aspect, the invention provides a method for transferring data from a data source to a handset using a cable having a first end configured to mate with the data source and a second end configured to mate with the handset. Preferably, the data is an animation file.

Another aspect of the invention provides a handset of a cordless telephone that is configured to receive a data file from a data source via a cable. The handset includes an input port configured to receive the data file and a screen configured to play the data file.

In another aspect, the invention provides a method that includes the following steps. First, an animation file is received by a handset of a cordless telephone from a data source. Second, the animation file is associated with an operation mode of the handset. Third, the animation file is executed by the handset during the operation mode.

### BRIEF DESCRIPTION OF THE DRAWINGS

FIG. 1 shows a layout of a handset of a cordless telephone and a data transfer cable in accordance with an embodiment of the invention.

FIG. 2 is a flowchart showing an exemplary process that can be used to implement an embodiment of the invention.

FIG. 3 is an exemplary screenshot of a handset screen of the invention during a process of the invention in which an operation mode of the cordless telephone is associated with a data file.

FIG. 4 is an exemplary screenshot of a data source during a data transfer process of the invention.

FIG. 5 shows how an animation file may be displayed on a handset screen having one row of dot matrix and one row of seven segment.

FIG. 6 is a schematic diagram showing an exemplary data transfer cable of the invention.

FIG. 7 is schematic diagram showing an exemplary interface between a headphone jack and a sound processor of a handset of the invention.

### DETAILED DESCRIPTION OF THE INVENTION

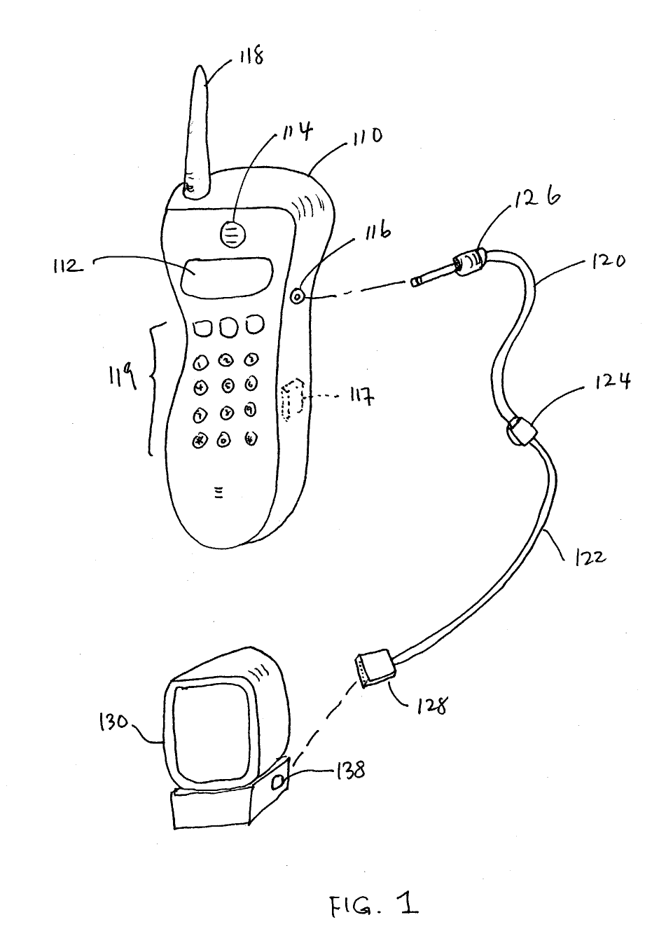

FIG. 1 shows a layout of a handset of a cordless telephone and a data transfer cable in accordance with an embodiment of the invention. Handset 110 is an exemplary handset of the invention. Cable 120 is an exemplary data transfer cable of the invention that transfers data files from data source 130 to handset 110. Data source 130 can be any known computing device. For example, data source 130 can be a laptop computer, a desktop computer, a terminal of a computer network, or another machine from which a data file can be received by handset 110 via cable 120.

Handset 110 includes screen 112, speaker 114, input port 116, microprocessor 1117, antenna 118, and keypad 119. Keypad 119 is a typical cordless telephone keypad that includes a number of buttons. Antenna 118 is configured to communicate with a base station (not shown) through RF signals. Microprocessor 117 is configured to execute a method of the invention.

Input port 116 is configured to receive data files from a data source. Data source 130 shown in FIG. 1 is an exemplary data source. Input port 116 is configured to mate with second end 126 of data transfer cable 120. Preferably, input port 116 is also configured to receive a headphone jack so that instead of playing sound through speaker 114, handset 110 can play the sound through a headphone (not shown) via input port 1116. Second end 126, accordingly, is preferably a headphone jack.

Speaker 114 is configured to render sounds including the voice of a party in communication with the user of handset 110. Speaker 114 is further configured to render sound associated with a data file transferred to handset 110 in accordance with the invention. Preferably, in addition to the sound component, the data file also includes an image component. Preferably, the data file is an animation file.

Screen 112 is configured to display images. For example, screen 112 is configured to display the image component of the data file mentioned above. Screen 112 can be an LCD screen. To implement the present invention, screen 112 preferably has a simple pattern LCD having at least one row of dot matrix. Although a full dot matrix LCD or a more advanced screen can be used as screen 112, the use of a simple LCD provides the animation capabilities of the invention without adding significant cost to produce handset 110.

Each data file is preferably associated with an operating mode of handset 110. The data file can be played or otherwise rendered via one or both of screen 112 and speaker 114. For example, a sound file can be rendered through speaker 114 when an incoming telephone call is received, and an image file can be displayed on screen 112 when a specific address entry is accessed by the user. Further, as an exemplary implementation of the invention, an animation file including both sound and moving images can be played via both screen 112 and speaker 114 when a different operation mode of handset 110 is activated. For example, when the battery of handset 110 drops below a certain threshold, an animation file can be played via both screen 112 and speaker 114 to alert the user.

Data transfer cable 120, in addition to second end 126, further includes cord 122, data converter 124, and first end 128. Preferably, second end 126 is a typical headphone jack. First end 128 is configured to mate with output port 138 of data source 130. Preferably, first end 128 is a USB plug if output port 138 is a USB port. Data converter 124 is configured to convert data of a first format received from data source 130 to data of a second format provided to handset 110. In an exemplary implementation of the invention, both the first and second formats are binary files. Preferably, the first format has USB v1.1 as the communications protocol. Preferably, the second format has EIA-232 (Electronic Industries Association) standard as the communications protocol. Preferably, data converter 124 can convert a USB v1.1 binary file received from data source 130 into an EIA-232 binary file that can be transferred or downloaded handset 110.

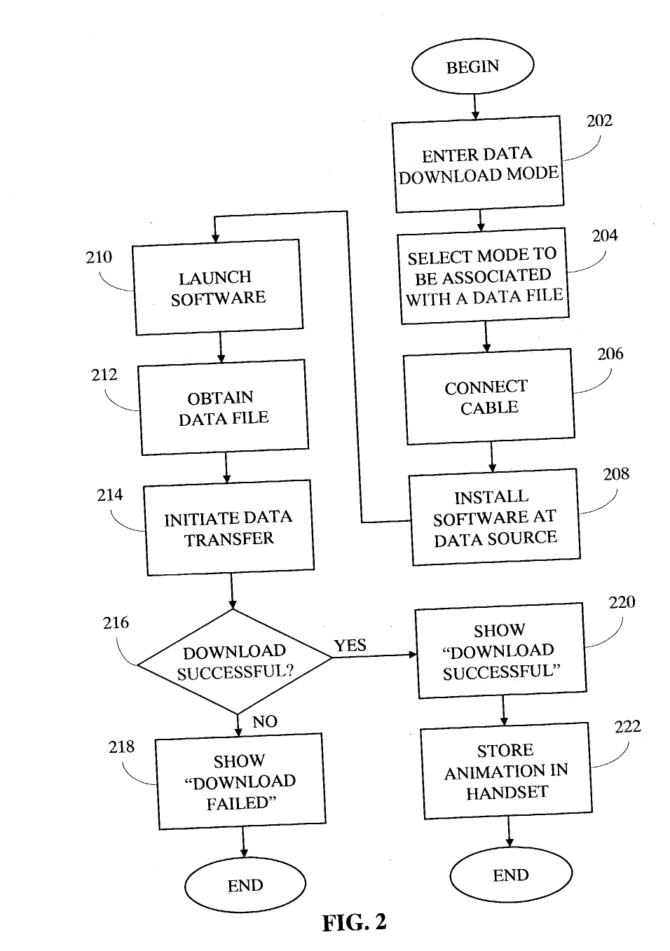

FIG. 2 is a flowchart showing an exemplary process that can be used to implement an embodiment of the invention. For clarity, handset 110 shown in FIG. 1 is referenced herein to help explain FIG. 2. It is not necessary to follow the order in which the following steps are described below to implement the invention.

In step 202, a data download mode is selected at handset 110. This can be performed by pressing or more buttons on keypad 119 of handset 110.

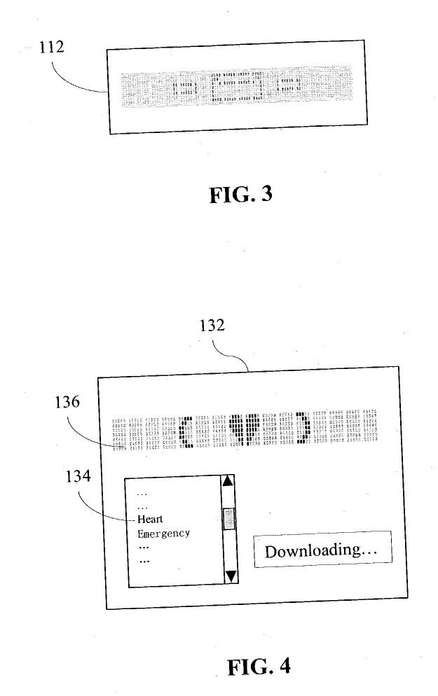

In step 204, using keypad 119, an operational mode with which a data file to be associated is selected. FIG. 3 is an exemplary screenshot of screen 112 of handset 110 during this operation. The operation mode can be, for example, the ringing of an incoming call from a specific calling party. For example, the user of handset 110 may associate the data file with the ringing of a call received from the user's mother.

In an exemplary implementation of the invention, the “appearance” of binary file is not shown during download of the binary file. Also, association of the call received with the animation is not done during the download operation, but during the creation of the phonebook entry. Preferably, handset 110 prompts the user if the user wants to associate the phonebook entry to a special animation which is already stored in handset 110.

Therefore, in step 204, keypad 119 can be used to select which animation is going to be replaced by the data file. When a handset key is pressed to confirm the download operation, handset 110 waits for a data signal from the data source 130. Preferably, screen 112 is configured to display “success” or “fail,” depending on the download status (see step 216).

In step 206, data transfer cable 120 is connected to handset 110 and data source 130. Second end 126 of data transfer cable 120 is mated with input port 116 of handset 110, and first end 128 is mated with output port 138 of data source 130.

In step 208, a software associated with the invention is installed at data source 130.

In step 210, the software associated with the invention is launched at data source 130.

In step 212, a data file is obtained at data source 130. This can be accomplished in many different ways. For example, a user could select the data file from an existing folder of data files within data source 130. Alternatively, the data file could be downloaded from an external source such as the Internet. A different method for obtaining the data file can include creating the data file itself at data source 130.

In step 214, the data transfer process is initiated. This can be initiated at either data source 130 or at handset 110. For example, one or more buttons of keypad 119 or data source 130 are pressed to initiate the data transfer or downloading process. FIG. 4 is an exemplary screenshot of data source 130 during a data transfer process of the invention. Field 134 of FIG. 4, displayed on screen 132 of data source 130, indicates a data file titled “heart” having a moving image 136 is being downloaded to handset 110.

In step 216, if the downloading process is not successful, the process goes to step 218. Otherwise, the process goes to step 220.

In step 218, handset 110 displays “download failed” and the process ends. In another embodiment, the process can return to one of the previous steps to resume the download process. Alternatively, trouble shooting steps may be invoked.

In step 220, handset 110 displays “download successful.” This indicates that the data file “heart” has been successfully transferred to handset 110.

In step 222, the downloaded data file is stored in the handset.

Preferably, the data file contains one or more of the following characteristics.

A preamble (a special data pattern) of the data file, which can indicate the correct starting of the download operation;

The name of the data file;

The size of the data file, which can provide the checking of the end of the download; and

The checksum of the file, which can provide the checking of error during the download operation.

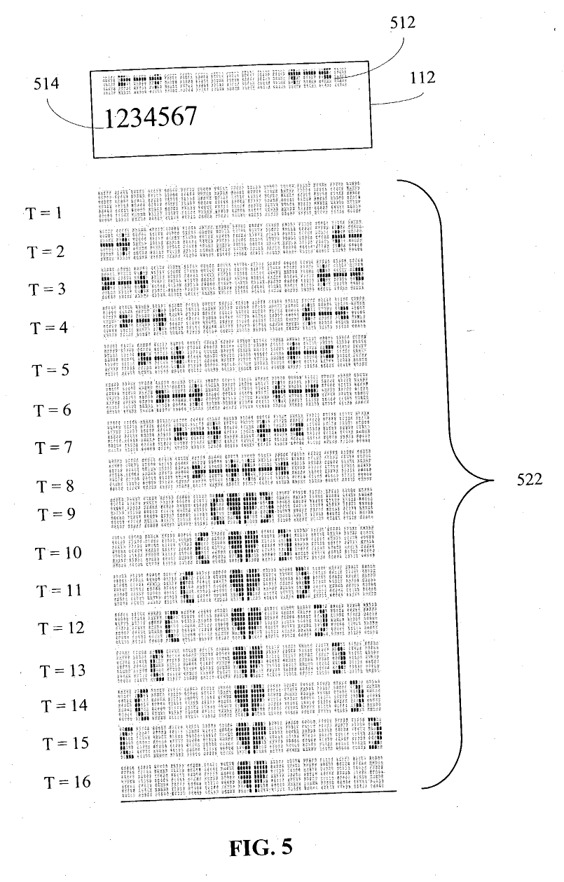

Following the steps described above, when handset 110 receives a call generated by the user's mother, the data file “heart” would be executed by microprocessor 117 of handset 110. FIG. 5 indicates how the “heart” data file may be displayed on screen 112 having one row of dot matrix 512 and one row of seven segment display 514. Sequence 522 indicates 16 frames of dot matrix 512 that appears on screen 112, one frame at a time, in the direction from t=1 to 1=16.

In another aspect, the invention can be configured to facilitate other operations. For example, the invention can be used to facilitate data synchronization between data source 130 and handset 110. For example, the date/time, address book, special ringer pattern, and the like, can be synchronized between data source 130 and handset 110 using data transfer cable 120.

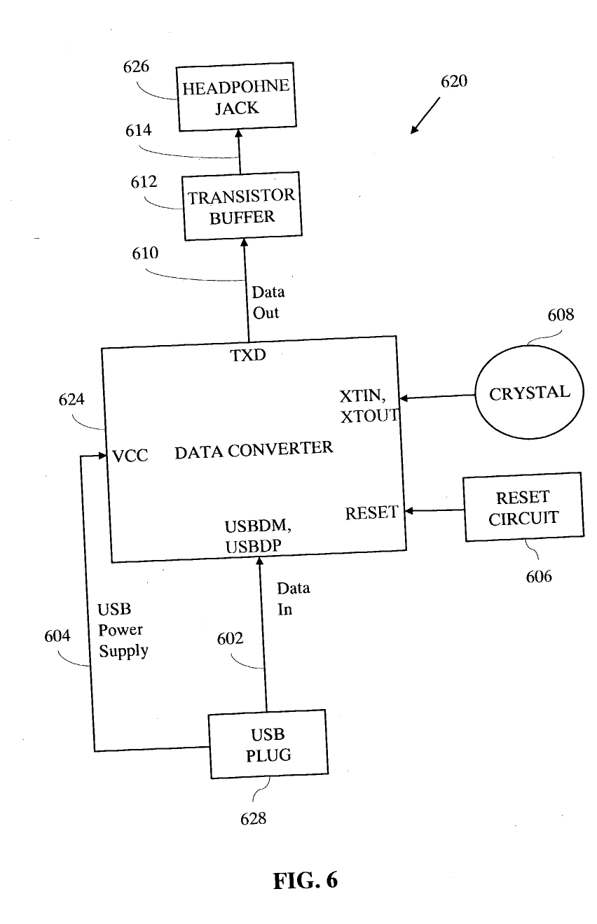

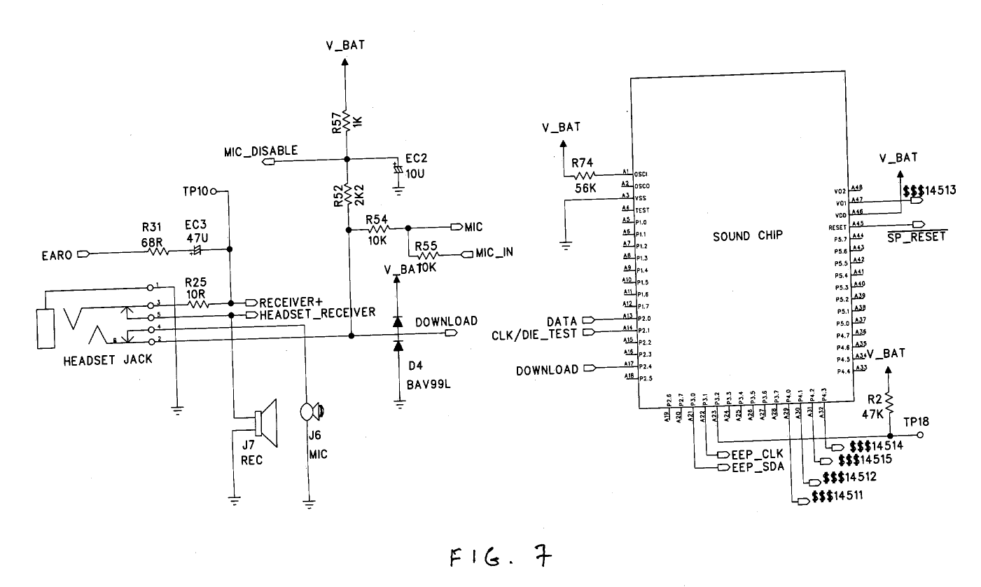

FIG. 6 is a schematic diagram showing an exemplary data transfer cable of the invention. Data transfer cable 620 includes first end 628, data converter 624, and second end 626, which are similar to corresponding first end 128, data converter 124, and second end 126 of cable 120, respectively.

As indicated in FIG. 6, first end 628 is preferably a USB plug which is configured to mate with a USB port of data source 130. Second 626 is preferably a headphone jack configured to mate with input port 116 of headphone 110.

Data converter 624 receives power from USB plug 628 via route 604. Data received from data source 130 through USB plug 628 enters data converter 624 via route 602. Data converter 624 includes reset circuit 606 and crystal 608. Preferably, crystal 608 is a 6 MHz crystal or even resonator. Reset circuit 606 can be simply a power-up reset circuit formed by RC network.

Data converter 624 outputs data to transistor buffer 612 via route 610. Transistor buffer 612 provides both voltage level conversion and to protect the data input circuit from an over-voltage damage. Out of transistor buffer 612, data is sent through route 614 to headphone jack 624, and subsequently to handset 110. Data converter 624 can be any ASIC which can convert USB data to serial type format.

FIG. 7 is schematic diagram showing an exemplary interface between a headphone jack and a sound processor of a handset of the invention. The invention uses the microphone input path as a data download path. For example, when second end 126 is mated with input port 116, the microphone of handset 110 is disconnected and the external data input pin is connected to the download pin of the sound processor. The sound chip captures the data from cable 120 while the download program start. In FIG. 7, D4 is a diode network that is configured to protect the sound chip from an over-voltage damage.

In a preferred implementation of the invention, the software indicated in step 208 of FIG. 2 includes the following specification.

Number of downloadable animation: 2-4

Number of frames per animation: 8-16

Number of pixels per frame: 16×5×7

Frame rate: 4 frames per second

Animation Packet size: about 256 bytes after compression

Data rate: 4800 bps

Download time per animation: 0.5 seconds

Packet Format: Each packet contains compressed animation frames with a 32 bytes overhead.

Compression method:

Bitmap based run-length coding—A bitmap picture is compressed by presenting the sequence of number of black and white dots.

Character based run-length coding—A bitmap picture is divided into 16 boxes which is called characters. Each character contains 5×7 pixels. The picture is compressed by presenting the sequence of characters.

The download operation is a simplex protocol, i.e., it is a one-directional data transfer from data source 130 to handset 110.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A cable comprising:
a first end configured to mate with a data source;
a second end configured to mate with a handset of a cordless telephone; and
a data converter for converting a first format of data received via the first end into a second format for delivery via the second end.

2. The cable of claim 1, wherein the first end comprises a USB plug.

3. The cable of claim 1, wherein the second end is a headphone jack.

4. The cable of claim 1, wherein the first format uses a USB v1.1 communications protocol and the second format uses an EIA-232 communications protocol.

5. A method comprising:
transferring data via a cable having a first end configured to mate with a data source and a second end configured to mate with a handset of a cordless telephone.

6. The method of claim 5, further comprising converting a first format of data received via the first end into a second format for delivery via the second end.

7. The method of claim 6, wherein the first format uses a USB v1.1 communications protocol and the second format uses an EIA-232 communications protocol.

8. The method of claim 5, wherein the first end is a USB plug.

9. The method of claim 5, wherein the second end is a headphone jack.

10. A method comprising:
having a data file at a data source;
converting the data file into a format usable by a handset of a cordless telephone; and
transferring the data file to the handset.

11. The method of claim 10, wherein the data file comprises a preamble of the data file.

12. The method of claim 10, wherein the data file comprises a name of the data file.

13. The method of claim 10, wherein the data file comprises a size of the data file.

14. The method of claim 10, wherein the data file comprises a checksum of the data file.

15. A handset of a cordless telephone comprising:
an input port configured to receive an animation file from a data source; and
a screen configured to play the animation file.

16. The handset of claim 15, wherein the input port is configured to receive a headphone jack.

17. The handset of claim 15, wherein the screen has at least one row of dot matrix.

18. A method comprising:
receiving an animation file from a data source via a cable having a first end and a second end;
associating the animation file with an operation mode of a handset of a cordless telephone; and
executing the animation file during the operation mode.

19. The method of claim 18, further comprising displaying animation associated with the animation file on a screen of the handset.

20. A handset of a cordless telephone comprising:
an input port configured to receive an animation file from a data source;
a microprocessor configured to execute the animation file during an operation mode of the handset; and
a screen for displaying animation associated with the animation file.
